(19) United States
(12) Patent Application Publication
(10) Pub. No.: US 2007/0229489 A1
(43) Pub. Date: Oct. 4, 2007

(54) Information processing apparatus and method of controlling the same

(76) Inventor: Hiroshi Terada, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/725,293

(22) Filed: Mar. 19, 2007

(30) Foreign Application Priority Data
Mar. 30, 2006 (JP) 2006-095056

(51) Int. Cl. G09G 5/00

(52) U.S. Cl. 345/213

(57) ABSTRACT

According to one embodiment, an information processing apparatus, includes a graphics controller, a signal outputting unit inputting a picture signal from the graphics controller, and a display unit receiving and displaying the picture signal output from the graphics controller, upon receiving a change signal from the graphics controller, the signal outputting unit stopping the output of the picture signal to the display unit, outputting a first signal to the display unit with a first synchronous signal to be changed as input from the graphics controller, correcting a changed second synchronous signal in synchronization with the first signal and outputting the second signal to the display unit after outputting the first signal, stopping the output of the second signal after outputting the second signal, and outputting the picture signal to the display unit.

### CROSS-REFERENCE TO RELATED APPLICATIONS

This application is based upon and claims the benefit of priority from Japanese Patent Application No. 2006-095056, filed Mar. 30, 2006, the entire contents of which are incorporated herein by reference.

### BACKGROUND

1. Field

One embodiment of the present invention relates to controlling a power supply of a notebook-type computer and, more particularly, to an information processing apparatus capable of smoothly changing outputs of picture signals and a method of controlling the information processing apparatus.

2. Description of the Related Art

It is disclosed by, in a notebook-type personal computer as disclosed in, for example, JP-A 6-178206 (KOKAI), for example, disturbance of screens of the display device at the change of output signals of GPU is reduced by turning off the power supply of the display device before changing the output signals and by turning on the power supply of the display device after changing the output signals (cf. JP-A 6-178206 (KOKAI)).

According to this technique, however, hardware control such as turning on/off the power supply of the display device is required, much time is required for the processing of turning on/off the power supply of the display device, and the screens cannot be changed at a high speed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a notebook-type computer as an information processing apparatus according to an embodiment of the present invention;

FIG. 2 is an exemplary block diagram showing a configuration of the notebook-type computer as the information processing apparatus according to the embodiment of the present invention;

FIG. 3 is an exemplary flowchart showing a controlling method of the information processing apparatus according to the embodiment of the present invention;

FIG. 4 is an exemplary flowchart showing a modified example of the controlling method of the information processing apparatus according to the embodiment of the present invention;

FIG. 5 is an exemplary illustration showing a modified example of the configuration of the information processing apparatus according to the embodiment of the present invention; and

FIG. 6 is an exemplary illustration showing a modified example of the configuration of the information processing apparatus according to the embodiment of the present invention.

### DETAILED DESCRIPTION

Various embodiments according to the invention will be described hereinafter with reference to the accompanying drawings. In general, according to one embodiment of the invention, an information processing apparatus, comprises: a graphics controller; a signal outputting unit inputting a picture signal from the graphics controller; and a display unit receiving and displaying the picture signal output from the graphics controller, upon receiving a change signal from the graphics controller, the signal outputting unit stopping the output of the picture signal to the display unit, outputting a first signal to the display unit with a first synchronous signal to be changed (which has been out before changing) as input from the graphics controller, correcting a changed second synchronous signal in synchronization with the first signal and outputting the second signal to the display unit after outputting the first signal, stopping the output of the second signal after outputting the second signal, and outputting the picture signal to the display unit.

An embodiment of the present invention will be described below with reference to the accompanying drawings.

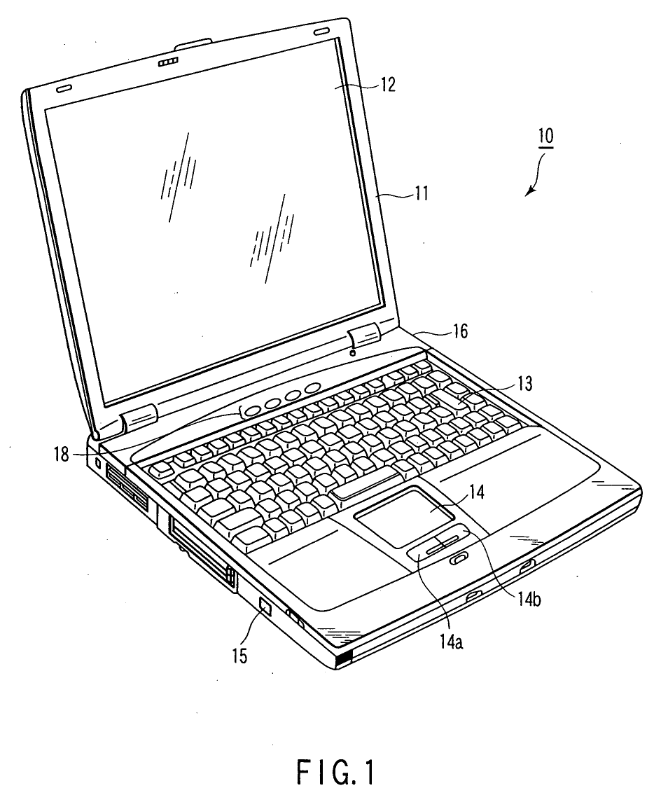

FIG. 1 is a perspective view showing an information processing apparatus according to the embodiment of the present invention. The information processing apparatus is implemented as a battery-operated notebook computer 10.

The computer 10 is composed of a main body 16 and a display unit 11 as shown in FIG. 1. A display device composed of an LCD (Liquid Crystal Display) is embedded in the display unit 11. A display screen 12 of the LCD is located approximately at the center of the display unit 11.

The display unit 11 is attached to the computer 10 so as to freely pivot between an opened position and a closed position. The main body of the computer 10 has a housing shaped in a thin box, and comprises a keyboard 13 on a top face, a touch pad 14 and two buttons 14a, 14b and shortcut buttons 18 such as a power supply button, a display change button, etc. on a palm rest thereof. An optical drive 15 is provided on a side face of the main body 16.

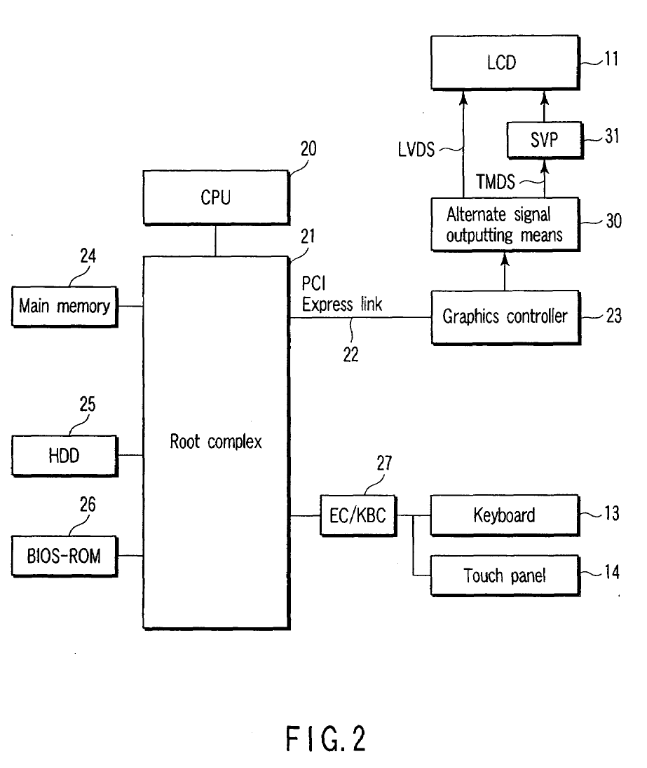

FIG. 2 is a block diagram showing the configuration of the computer.

The computer 10 comprises a CPU (Central Processing Unit) 20, a Root Complex 21, a main memory 24, a graphics controller (graphics processing unit:GPU) 23, a PCI Express Link 22 making a connection between the Root Complex 21 and the graphics controller 23, the display unit 11, an embedded controller/keyboard controller IC (EC/KBC) 27, a hard disk drive (HDD) 25, a BIOS-ROM 26, and the acceleration sensor 17, keyboard 13 and touch pad 14 serving as input devices connected to the EC/KBC 27, etc.

The Root Complex 21, the graphics controller 23, etc. are devices in conformity with the PCI EXPRESS standards. The communications between the Root Complex 21 and the graphics controller 23 are executed over the PCI Express Link 22 arranged between the Root Complex 21 and the graphics controller 23.

The CPU 20 is a processor controlling the operations of the computer 10, and executes various kinds of programs (operating system and application systems) loaded on the main memory 24 by the HDD 25. In addition, the CPU 20 also executes the BIOS (Basic Input Output System) stored in the BIOS-ROM 26. The BIOS is a program for controlling the hardware.

The Root Complex 21 is a bridge device making a connection between a local bus of the CPU 20 and the graphics controller 23. In addition, the Root Complex 21 also has a function of executing the communications with the graphics controller 23 over the PCI Express Link 22.

The graphics controller 23 is a display controller which controls the display unit 11 employed as a display monitor of the computer. The graphics controller 23 outputs a TMDS signal which passes through a high picture quality circuit (SVP) via alternate signal outputting means (alternate signal outputting unit) 30, and an LVDS signal which does not pass through the high picture quality circuit (SVP), to the LCD serving as the display device.

The EC/KBC 27 is a one-chip microcomputer on which an embedded controller for power management and a keyboard controller controlling the keyboard 13 and the touch pad 14 are integrated. The EC/KBC 27 has a function of controlling power-on/power-off of the computer 10, in cooperation with a power supply controller, in response to the user's operation of the power button.

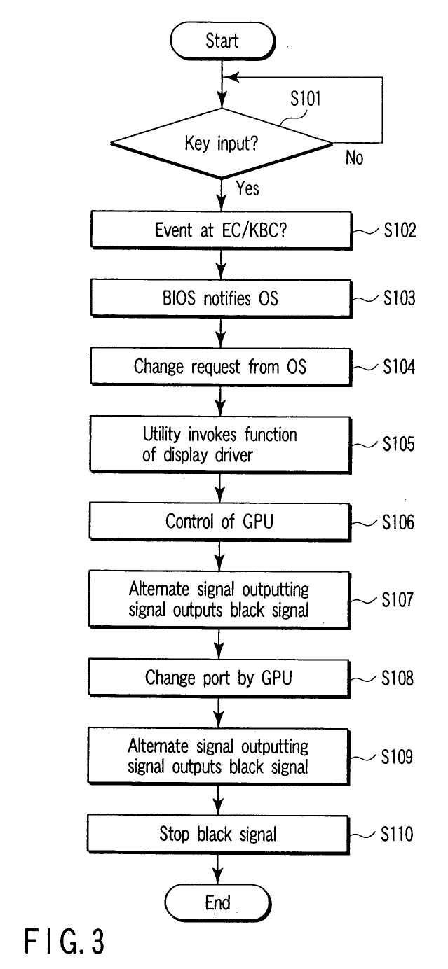

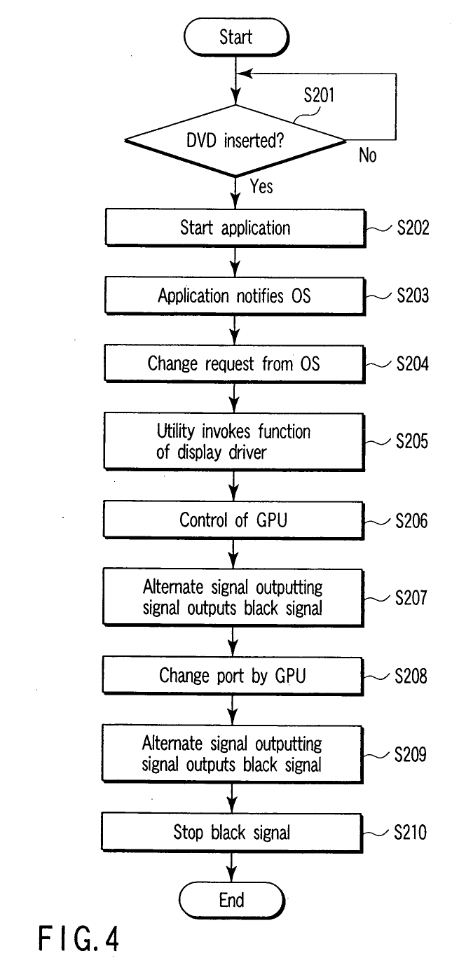

Next, a control method of the information processing apparatus according to the embodiment of the present invention is described with reference to a flowchart of FIG. 3.

At a key input of the display change short-cut key 18 (YES in step S101), an event occurs at the EC/KBC 27 (step S102). Subsequently, the system BIOS notifies the OS (Operating System) of a display change request (step S103). The OS receiving the display change request outputs the change request to the utility (step S104). When the change request is received, the utility invokes a changing function of the display driver (step S105). The display driver controls the GPU (graphics controller) (step S106). The system BIOS urges the alternate signal outputting means 30 to sample the synchronous signal (first synchronous signal) which is input from the GPU 23 and output, for example, a black level signal as an alternate signal by using the sampled first synchronous signal (step S107). The first synchronous signal is a synchronous signal which is output from the GPU 23 before the changing.

At this time, the alternate signal outputting means 30 stops the output of the picture signal which is input from the GPU to the SVP 30, to the LCD 11.

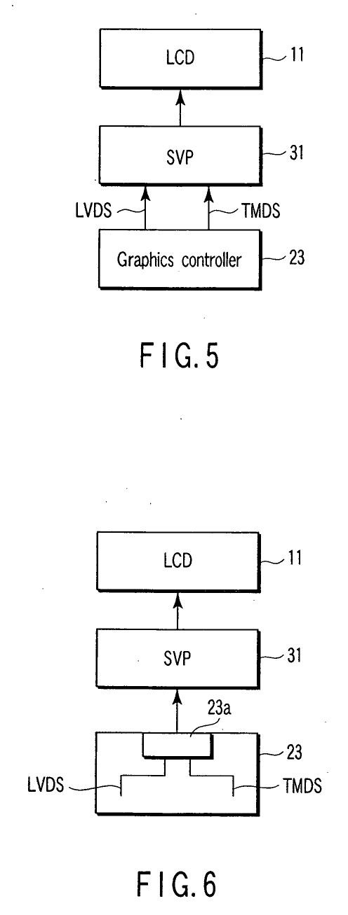

The port prepared by the GPU 23 is changed from the LVDS to TMDS (step S108; cf. FIG. 5). The display driver notifies the system BIOS of the end of changing, and the system BIOS urges the alternate signal outputting means 30 to sample the changed synchronous signal (second synchronous signal) which is input from GPU 23, correct the sampled signal in synchronization with the first synchronous signal and output a black level signal as an alternate signal by using the corrected second synchronous signal (step S109). After that, the black level signal is stopped (step S110), the picture signal which is input from the GPU to the SVP 30 is output to the LCD 11, and the changing operation is ended. The above change of the output signal from the GPU is employed when, for example, the resolution of the display device is changed.

By employing the present embodiment, as described above, the output signal from the GPU can easily be changed at a high speed without executing the hardware control.

In the above embodiment, the case of pushing down the display change shortcut key 18 is described. As a modified example, however, when a DVD is inserted, for example, the output signal from the GPU can be automatically changed for optimum resolution for reproduction of the DVD.

In other words, when insertion of the DVD is confirmed (YES in step S201), an application for DVD reproduction is started (step S202). The started application notifies the OS that the request for DVD reproduction has been made (step S203). The OS receiving the display change request makes the change request for the utility (step S204). After that, the same processing as that in step S105 to step S110 is executed in step S205 to step S210.

As describe above, even at the automatic reproduction of the DVD following the insertion thereof, the output signal from the GPU can be easily changed at a high speed without executing the hardware control for the optimum resolution.

In addition, in the above embodiment, the graphics controller 23 outputs a TMDS signal which passes through a high picture quality circuit (SVP) via alternate signal outputting means 30, and an LVDS signal which does not pass through the high picture quality circuit (SVP), to the LCD serving as the display device. As shown in FIG. 5, however, the alternate signal outputting means may be built in a high picture quality circuit (SVP) 30 such that the LVDS signal can pass through the high picture quality circuit (SVP) 30 and output. Moreover, a signal integrator 23a may be provided at the graphics controller 23, the TMDS signal and the LVDS signal may be integrated by the signal integrator 23a, and the output ports from the graphics controller 23 may be integrated to a single port as shown in FIG. 6.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a graphics controller;
a signal outputting unit inputting a picture signal from the graphics controller; and
a display unit receiving and displaying the picture signal output from the graphics controller,
upon receiving a change signal from the graphics controller, the signal outputting unit stopping the output of the picture signal to the display unit, outputting a first signal to the display unit with a first synchronous signal to be changed as input from the graphics controller, correcting a changed second synchronous signal in synchronization with the first signal and outputting the second signal to the display unit after outputting the first signal, stopping the output of the second signal after outputting the second signal, and outputting the picture signal to the display unit.

2. The apparatus according to claim 1, wherein the graphics controller is built in the signal outputting unit.

3. The apparatus according to claim 1, wherein the graphics controller comprises at least two picture output ports.

4. The apparatus according to claim 1, wherein the graphics controller comprises an integrating unit integrating at least two picture signal outputs to a one output.

5. An information processing apparatus, comprising:
a graphics controller;
a signal outputting unit inputting a picture signal from the graphics controller; and
a display unit receiving and displaying the picture signal output from the graphics controller,
upon receiving a change signal from the graphics controller, the signal outputting unit stopping the output of the picture signal, sampling a first synchronous signal to be changed as input from the graphics controller, outputting the sampled first synchronous signal and a preset predetermined color level signal to the display unit as a first signal, sampling a changed synchronous signal after outputting the first signal, correcting the sampled synchronous signal as a second synchronous signal in synchronization with the first signal and outputting the second synchronous signal and a preset predetermined color level signal to the display unit as a second signal, stopping the output of the second signal after outputting the second signal, and outputting the picture signal to the display unit.

6. The apparatus according to claim 5, wherein the graphics controller is built in the signal outputting unit.

7. The apparatus according to claim 5, wherein the graphics controller comprises at least two picture output ports.

8. The apparatus according to claim 5, wherein the graphics controller comprises an integrating unit integrating at least two picture signal outputs to a one output.

9. The apparatus according to claim 5, wherein the predetermined color level signal is a black level signal.

10. A controlling method, comprising:
upon receiving a change signal from a graphics controller, stopping output of a picture signal input from the graphics controller to a display unit, and outputting a first signal to the display unit with a first synchronous signal to be changed as input from the graphics controller;
after outputting the first signal, correcting a changed second synchronous signal in synchronization with the first signal and outputting a second signal to the display unit; and
after outputting the second signal, stopping the output of the second signal, and outputting the picture signal to the display unit.
